(19) United States
(12) Patent Application Publication
(10) Pub. No.: US 2016/0332506 A1
(43) Pub. Date: Nov. 17, 2016

(54) MOTOR VEHICLE HEAT TRANSFER SYSTEM

(71) Applicant: BENTELER AUTOMOBILTECHNIK GMBH, Paderborn (DE)

(72) Inventors: Felix RUBITSCHEK, Paderborn (DE); Sven PRZYBYLSKI, Paderborn (DE); Tobias DÜPMEIER, Paderborn (DE)

(73) Assignee: BENTELER AUTOMOBILTECHNIK GMBH, Paderborn (DE)

(21) Appl. No.: 15/152,154

(22) Filed: May 11, 2016

(30) Foreign Application Priority Data
May 12, 2015 (DE) 10 2015 107 427.3

(51) Int. Cl. B60H 1/20; B60H 1/00; F28D 15/02

(52) U.S. Cl. CPC B60H 1/20; F28D 15/0266; B60H 1/00314; F28D 15/025; F28D 2015/0216

(57) ABSTRACT

A motor vehicle heat transfer system includes a closed circuit for an operating medium, said closed circuit comprising an evaporator and a condenser arranged in the motor vehicle above the evaporator, wherein the operating medium evaporates in the evaporator and flows to the condenser and wherein liquid operating medium, which has condensed in the condenser, is conducted back into the evaporator via a return line based on gravity.

### CROSS-REFERENCES TO RELATED APPLICATIONS

This application claims the priority of German Patent Application, Serial No. 10 2015 107 427.3, filed May 12, 2015, pursuant to 35 U.S.C. 119(a)-(d), the content of which is incorporated herein by reference in its entirety as if fully set forth herein.

### BACKGROUND OF THE INVENTION

The present invention relates to a motor vehicle heat transfer system.

The following discussion of related art is provided to assist the reader in understanding the advantages of the invention, and is not to be construed as an admission that this related art is prior art to this invention.

Due to the increasing efficiency of internal combustion engines the cooling water is only heated slowly at low ambient temperatures, in particular in cold seasons. This results in a heat deficit for the interior heating of motor vehicles by means of known water heaters. For this reason in particular in diesel vehicles, electric auxiliary heaters, so called PTC (Positive Temperature Coefficient) heaters are installed standardly in the air conditioning module. Such an auxiliary heater heats the air that flows into the interior. However, the electric energy required for operation leads to a significant increase in fuel consumption.

From the state of the art different approaches are known which seek to lower the heat deficit, in particular by using exhaust gas heat exchangers with which the cooling water is heated faster by exhaust gas heat.

Heat pipes, including loop heat pipes, work purely passively, self-regulating and without additional pump. The heat transport is accomplished by utilizing evaporation enthalpy, whereby losses of sensible heat via a vapor line are insignificant. As a result heat pipes enable a very efficient heat transport. A disadvantage of heat pipes is the limited transport efficiency during vibration. Vibrations, for example caused by motor oscillations or impacts resulting from driving, generate forces that act on the operating medium of the heat pipes in the capillary structure and thereby impede the flow for the operating medium or may even lead to leakage of the operating medium from the capillary structure. In heat pipes of the circuit type or loop heat pipes this problem is less pronounced; however, the construction and the manufacture of loop heat pipe evaporators for utilization of exhaust gas heat are comparatively complex. Because exhaust gas and liquid and vaporous operating medium have to be separated from each other, corresponding sealing concepts are required. Moreover the demands on the capillary structure regarding pore size and porosity result in comparatively expensive components.

it would therefore be advantageous and desirable to provide an efficient and cost-effective motor vehicle heat transmission system, which enables a heat transport from the exhaust gas to a receiver in the motor vehicle, in particular an internal heating of the motor vehicle, without requiring an additional pump.

### SUMMARY OF THE INVENTION

According to one aspect of the present invention, a motor vehicle heat transfer system includes a closed circuit for an operating medium, wherein the closed circuit includes an evaporator and a condenser arranged in the motor vehicle above the evaporator, wherein the operating medium evaporates in the evaporator and flows to the condenser and wherein liquid operating medium, which has condensed in the condenser, is conducted back into the evaporator via a return line based on gravity. The evaporator is in contact with a heat source of the motor vehicle. The heat source can be the hot exhaust gas from the internal combustion engine of the motor vehicle. The evaporator is arranged in the exhaust gas stream of the internal combustion engine of the motor vehicle and comes into heat-conducting contact with the exhaust gas. For evaporation of the operating medium in the evaporator other heat sources of the motor vehicle can also be used, for example the waste heat of electric components or the power electronics of an electric vehicles. Also the electric motor of a motor vehicle itself can act as the heat source, wherein the waste heat of the electric motor is used for evaporation of the operating medium in the motor vehicle heat transfer system.

The operating medium is evaporated in the evaporator from where it flows to the condenser arranged in the motor vehicle above the evaporator. In the condenser a heat exchange with a user takes place, wherein the vaporous operating medium is condensed and liquefied. The return of the liquid operating medium to the evaporator is based on gravity.

The condenser can in particular be an air-cooled condenser in the air conditioning module of the motor vehicle or the condenser of an internal heating of the motor vehicle. The condenser can also be a component of a heating unit for drive components such as the gear shift or the motor oil itself.

Because the operating medium is transported in the closed circuit solely based on density differences in the system or in the circuit, i.e., based on free convection, a pump is not required, which lowers the complexity and the costs of the motor vehicle heat transmission system. The operating medium may in particular be ethanol. Of course also water or other operating media are possible.

According to another advantageous feature of the invention, the motor vehicle heat transfer system further includes a vapor collecting chamber assigned to the evaporator, in which collecting chamber the vapor, which flows out of the evaporator, is collected and conducted to the condenser.

Generally the evaporator can be constructed according to the parallel flow principle in which the exhaust gas and the vapor flow in the same direction or according to the counter flow principle. In the counter flow principle the substances flow in opposite directions.

According to another advantageous feature of the invention, the evaporator includes at least one evaporator module with a housing. The housing is in contact with the exhaust gas stream. In the housing a heat exchanger structure is integrated. The heat exchanger structure are means for increasing the heat transmission surface and/or for increasing the evaporation rate. Preferably these means have a porous configuration. In particular a heat exchanger structure may be made of an insert of a wire mesh of a metal nonwoven. Preferably a material with good heat conducting properties can be used as material for a heat exchanger structure.

According to another advantageous feature of the invention, a compensating container for the operating medium is arranged upstream of the evaporator, In particular the compensation container is integrated in the return line.

The exhaust gas conducted out of the internal combustion engine comes into contact with the evaporator as exhaust gas stream. Generally it may be sufficient that the exhaust gas flows along only one side of the evaporator. A practical advantageous embodiment provides that the evaporator has a through passage for the exhaust gas stream. In particular a central through passage for the exhaust gas stream is provided in the evaporator. In this context it is further advantageous when multiple evaporator modules are combined to form an evaporator.

According to another advantageous feature of the invention, the plate-shaped evaporator modules are arranged relative to each other so that one or multiple through-passages for the exhaust gas stream are formed between them. In a simple construction the plate-shaped evaporator modules are made of a housing shell or trough which is closed by a cover. In the internal space of the evaporator module a heat exchanger structure is integrated and spaced-apart from the walls via spacers.

Preferably the exhaust gas stream is conducted centrally through the evaporator. The evaporator modules that are combined into the evaporator thus form a passage, in particular a central passage, for the exhaust gas. In the passage or the passages means for increasing the heat transfer surface can be provided in particular ribs, webs or lamellas. An advantageous embodiment provides that the means for increasing the heat transfer surface are formed by soldered-in heat exchange fins, The exhaust gas flows between the heat exchange fins along the bottom walls of the housing shells. This ensures a very good heat transfer.

Compared to systems with a heat pipe, in particular a heat pipe of the circuit type or loop heat pipe, this has the advantage that neither a capillary structure nor a sealing concept for separating vapor and liquid phase is required in the evaporator. Instead of a capillary structure a porous heat exchanger structure, for example a wire mesh or a metal nonwoven is used for increasing the evaporation rate. The motor vehicle heat transfer system according to the invention is less complex and with this its manufacture more cost-effective.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 a schematic representation of a motor vehicle heat transfer system according to the invention, and

FIG. 2 a schematic longitudinal sectional view of a heat exchanger module of the motor vehicle heat transfer system according to the invention.

### DETAILED DESCRIPTION OF PREFERRED EMBODIMENTS

Throughout all the Figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

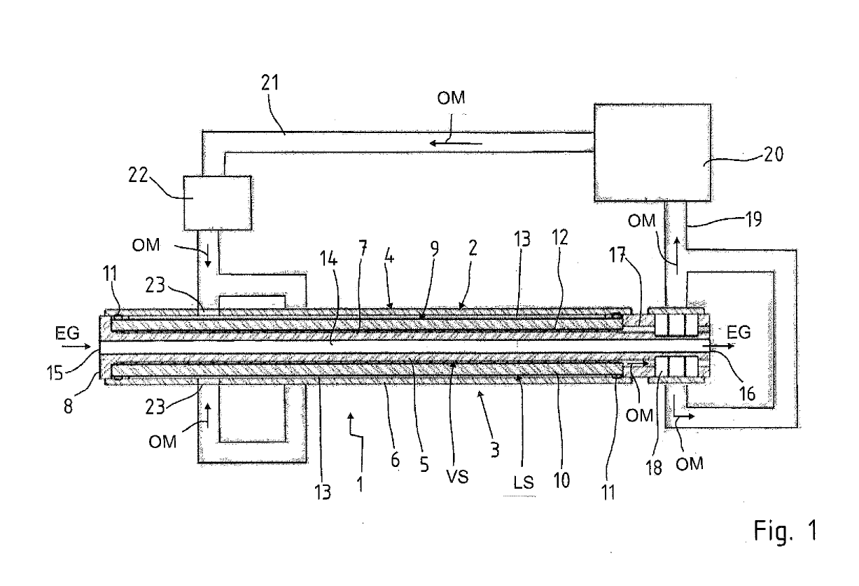

The motor vehicle heat transfer system includes a closed circuit for an operating medium OM and has an evaporator 1, which is integrated in the exhaust gas stream of an internal combustion engine of a motor vehicle. The exhaust gas stream or the exhaust gas is indicated in FIG. 1 by the arrow EG.

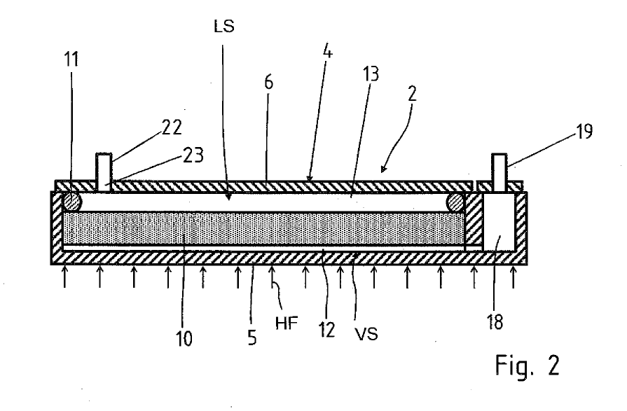

The evaporator 1 includes two plate-shaped evaporator modules 2, 3 (see also FIG. 2). Each evaporator module 2, 3 has a housing 4 formed by a housing shell 5 and a cover 6. The housing shell 5 has a bottom wall 7 with a circumferential border 8. The bottom wall is in direct contact with the exhaust gas EG. In the housing 4 a heat exchanger structure 9 is arranged. The heat exchanger structure 9 is formed by elements for enlarging the heat transfer surface and increasing the evaporation rate. The heat exchanger structure 9 has in particular a porous configuration and is made of metal. In particular the means is a sintered plate body 10. The plate body 10 is aligned with the housing shell 5 and sealed relative to the cover 6 via spacers 11. The spacers 11 are formed by gaskets. On the vapor side VS of the plate body 10 which faces the bottom wall 7, vapor channels 12 are provided. The vapor channels 12 are configured one-piece with material unity in the plate body 10. On the opposite liquid side LS of the evaporator module 2, 3 a distributor space 13 is located for distributing the liquid operating medium via the liquid side LS of the plate body 10.

The upper evaporator module 2 and the lower evaporator module 3 are combined into the evaporator 1 and form a passage 14 between the upper and lower evaporator modules 2, 3 for the exhaust gas stream EG. The exhaust gas enters the evaporator 1 via the exhaust gas inlet 15 of the evaporator 1 and is conducted through the passage 14 up to the exhaust gas exit 16. Hereby the heat is transferred from the exhaust gas to the evaporator 1 and the operating medium OM. The heat flux is indicated in FIG. 2 by the arrows HF. The operating medium OM is heated in the evaporator 1 above the evaporating temperature of the operating medium OM, so that the operating medium evaporates in the evaporator 1. The evaporator 1 is operated according to the parallel flow principle, i.e., exhaust gas EG and vaporous operating medium OM flow in the same direction. At the end side of each evaporator module 2, 3 the vaporous operating medium OM enters the vapor colleting chamber 18 via a vapor outlet 17. From the vapor collecting chamber 18 the vaporous operating medium OM flows via a vapor line 19 to a condenser 20 arranged in the motor vehicle above the evaporator 1. In the condenser 20 the vaporous operating medium OM gives off heat to a user. In particular the condenser 20 is a component of the internal heating of the motor vehicle and/or an air conditioning module. Due to the heat given off by the vaporous operating medium, the vaporous operating medium OM is liquefied in the condenser 20 and due to gravity flows back into the evaporator 1 via a return line 21. Arranged upstream of the evaporator 1 is a compensating container 22 for the operating medium OM, which is integrated in the return line 21. The liquid operating medium OM respectively enters the evaporator modules 2, 3 of the evaporator again via an inlet 23.

The motor vehicle heat transfer system according to the invention does not require an additional pump.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A motor vehicle heat transfer system, comprising a closed circuit for an operating medium, said closed circuit comprising an evaporator and a condenser arranged in the motor vehicle above the evaporator, wherein the operating medium evaporates in the evaporator and flows to the condenser and wherein liquid operating medium, which has condensed in the condenser, is conducted back into the evaporator via a return line based on gravity.

2. The motor vehicle heat transfer system of claim 1, further comprising a vapor collecting chamber assigned to the evaporator.

3. The motor vehicle heat transfer system of claim 1, wherein the evaporator comprises at least one evaporator module, said at least one evaporator module comprising a housing and a heat exchanger structure arranged in the housing.

4. The motor vehicle heat transfer system of claim 3, wherein the heat exchanger structure is configured porous.

5. The motor vehicle heat transfer system of claim 1, further comprising a compensation container for the operating medium arranged upstream of the evaporator.

6. The motor vehicle heat transfer system of claim 1, wherein the evaporator has a passage for the exhaust gas stream.
